(19) United States
(12) Patent Application Publication
(10) Pub. No.: US 2009/0021629 A1
(43) Pub. Date: Jan. 22, 2009

(54) SOLID STATE IMAGING DEVICE

(76) Inventor: Tomoki YAMADA, Miyagi (JP)

Correspondence Address: BIRCH STEWART KOLASCH & BIRCH, PO BOX 747, FALLS CHURCH, VA, 22040-0747, US

(21) Appl. No.: 12/174,318

(22) Filed: Jul. 16, 2008

(30) Foreign Application Priority Data
Jul. 17, 2007 (JP) 2007-185770

(51) Int. Cl. H04N 5/335; H04N 5/225

(52) U.S. Cl. 348/311; 348/340; 348/E05.091; 348/E05.025

(57) ABSTRACT

A solid state imaging device includes color pixels to generate color signals and white pixels to generate luminance signals. The color pixels are arranged in a checkered pattern, and the white pixels are surrounded by the color pixels. Each color pixel has a light receiving element, a color filter and a first micro-lens. Each white pixel has a light receiving element and a second micro-lens. The first micro-lens is higher than the second micro-lens, so that an incident angle range is wide on the first micro-lens. The color pixels achieve better light-collection efficiency for oblique incident light than the white pixels.

### FIELD OF THE INVENTION

The present invention relates to a solid-state imaging device for color images.

### BACKGROUND OF THE INVENTION

Digital cameras and other electronic cameras incorporate a solid state imaging device of, such as, CCD (Charge Coupled Device) type or CMOS (Complementary Metal Oxide Semiconductor) type. To produce color images, a plurality of color pixels that photo-electrically convert color light are arranged in a matrix in the solid state imaging device. Each color pixel is composed of a light receiving element and a color filter disposed on the light receiving element.

Generally, three types of the color filters, corresponding to the light's three primary colors, red (R), green (G) and blue (B) are used, so that the color pixels of three different colors (hereinafter referred to as R pixels, G pixels and B pixels, according to the color of the color filter) are formed. A common arrangement of the color filters (i.e., arrangement of the color pixels) is Bayer arrangement, in which the G colors are arranged in a checkered pattern, and the R and B colors are evenly allocated to the remaining positions. With the Bayer arrangement, since R, G or B light is detected at each pixel position, the color information and the luminance information at each pixel position can be obtained by estimate calculation using the pixel values of the adjoining color pixels.

In the Bayer arrangement, the G pixels are twice as many as the R pixels or the B pixels. When a photographic subject is green, high luminance resolution is achieved in the resultant image because most of the luminance information is obtained from the green pixels. When a photographic subject is red or blue, on the other hand, the luminance resolution is reduced approximately by half because most of the luminance information is obtained from the red or blue pixels. Namely, the Bayer arrangement has the problem that the luminance resolution is deteriorated depending on the color of a subject.

In view of this, there is disclosed a solid state imaging device which arranges all the color pixels (R, G and B pixels) in a checkered pattern, and places white (W) pixels in the remaining positions, so as to detect the color information and the luminance information separately, and eliminate color dependence of the luminance resolution (see, Japanese Patent Laid-open Publication No. 2003-318375). These W pixels are provided with a brightness filter such as a highly-transmissive clear or white filter, in place of the color filter. The W pixels, having a spectroscopic property correlative with brightness, detect the luminance information of a subject. This solid state imaging device achieves high sensitivity, as well as eliminating the color dependence of the luminance resolution.

In the solid state imaging device of the publication No. 2003-318375, the difference in sensitivity will vary greatly between the color pixels and the W pixels when all the pixels have the same structure. Even under the same exposure condition, luminance signals from the W pixels are substantially four times as many as color signals from the color pixels. This unbalance of the color signals and the luminance signals prevents producing high-quality color images. In view of this problem, Japanese Patent Laid-open Publication No. 2007-104178 discloses reducing the light-receiving area of the W pixels smaller than the light-receiving area of the color pixels so as to improve the balance of the color signals and the luminance signals.

However, in the solid state imaging device of the publication No. 2007-104178, the W pixel are arranged in stripes along the column direction, different from the checkered pattern disclosed in the publication No. 2003-318375. This is because that arranging the W pixels in checkered pattern is inefficient in layout, and possibly places restrictions on overall pixel arrangement. Additionally, while the solid state imaging device of the publication No. 2007-104178 improves the balance between the color signals and the luminance signals, it has the problem that the luminance resolution of a resultant image is off balanced, lower in the row direction than in the column direction.

### SUMMARY OF THE INVENTION

In view of the foregoing, an object of the present invention is to provide a solid state imaging device capable of balancing color signals and luminance signals by using color pixels and white pixels of the same size, without placing restrictions on pixel arrangement.

Another object of the present invention is to provide a solid state imaging device capable of simultaneously improving a balance between the color signals and luminance signals and a balance of luminance resolution between a row direction and a column direction, so as to produce higher quality color images.

In order to achieve the above and other objects, a solid state imaging device according to the present invention includes regularly-arranged color pixels and white pixels. Each color pixel is composed of a first light receiving element at a particular position, a color filter disposed on a light incident side of the first light receiving element, and a first micro-lens disposed on a light incident side of the color filter. Each white pixel is composed of a second light receiving element adjoining at least one first light receiving element, and a second micro-lens disposed on a light incident side of the second light receiving element and having a lower vertex than the first micro-lens. These light receiving elements are arranged in a matrix in a semiconductor substrate and photo-electrically convert incident light into signal charge.

Preferably, the color pixels are arranged in a checkered pattern, and the white pixels are arranged in a checkered pattern to be surrounded by the color pixels.

It is preferred to provide, on the semiconductor substrate, a planarizing layer having a flat top surface to support the color filters. In this case, the second micro-lenses are formed directly on said planarizing layer, while the first micro-lenses are formed on the color filters.

Preferably, the color pixels are red pixels having red filters to transmit red light, green pixels having green filters to transmit green light, and blue pixels having blue filters to transmit blue light.

It is also preferred to provide a plurality of vertical CCDs, a horizontal CCD, and an output amplifier. The vertical CCDs extend along each column of the light receiving elements, so as to receive the signal charge from each light receiving element and transfer the signal charge to a vertical direction of the matrix. The horizontal CCD receives and transfers the signal charge from each vertical CCD to a horizontal direction of the matrix. The output amplifier receives the signal charge from the horizontal CCD, converts the signal charge into voltage signal, and then outputs the voltage signal.

According to the present invention, the first micro-lenses cover a wider incident angle range than the second micro-lenses, and thus light-collection efficiency for oblique incident light is improved. The color signals from the color pixels become more intense relative to the luminance signals form the white pixels, and the balance of the color signals and the luminance signals is improved. Additionally, since it is possible to balance the color signals and the luminance signals by using the color pixels and the white pixels of the same size, there is no restriction on the pixel arrangement.

Since the color pixels are arranged in a checkered pattern, and the white pixels are arranged in a checkered pattern to be surrounded by the color pixels, the balance of the color signals and luminance signals, and the balance of luminance resolution between the row and column directions are improved simultaneously. It is therefore possible to produce higher quality color images than before.

### BRIEF DESCRIPTION OF THE DRAWINGS

The above objects and advantages of the present invention will become more apparent from the following detailed description when read in connection with the accompanying drawings, in which:

FIG. 1 is a plan view schematically illustrating the configuration of a solid state imaging device according to the present invention;

FIG. 2 is an explanatory view of pixel arrangement;

FIG. 3 is a cross-sectional view along the III-III line of FIG. 1;

FIG. 4 is a cross-sectional view along the IV-IV line of FIG. 1;

FIG. 5 to FIG. 7 are cross-sectional views illustrating a manufacturing process of the solid state imaging device;

FIG. 8 is an explanatory view of a honeycomb arrangement of pixel; and

FIG. 9 is an explanatory view of a stripe arrangement of pixel.

### DETAILED DESCRIPTION OF THE PREFERRED EMBODIMENTS

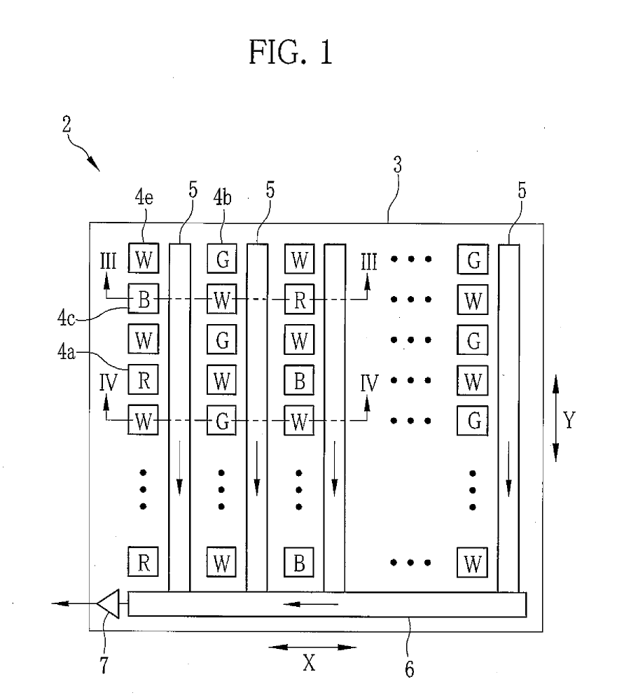

Referring to FIG. 1, there is shown a solid state imaging device 2 of, for example, an interline transfer CCD in which a plurality of R pixels 4a, G pixels 4b, B pixels 4c and W pixels 4e of the same size are arranged into rows (X direction) and columns (Y direction) of a matrix (square grid) on a semiconductor substrate 3. Each of the R, G and B pixels 4a, 4b, 4c is composed of a light receiving element (photoelectric conversion element), a corresponding color filter and a micro-lens both disposed on a light incident side of the light receiving element, and detects color information of a photographic subject. These color pixels generate and store the signal charges proportional to the amount of incident light with corresponding color. The W pixels 4e, on the other hand, detect the luminance information of a photographic subject. The W pixel 4e is composed of a light receiving element and a micro-lens disposed, without a color filter, on a light incident side of the light receiving element, and generates and stores the signal charges proportional to the brightness of incident light.

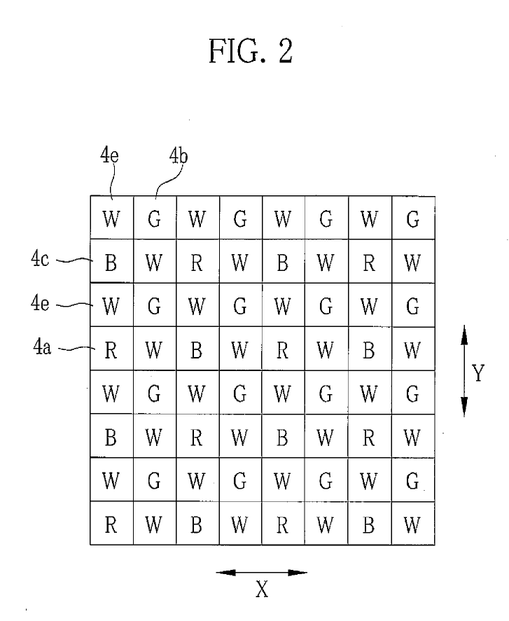

As shown in FIG. 2, the R, G, B color pixels 4a, 4b, 4c are arranged in a checkered pattern in a square grid, while the W pixels 4e are allocated to the remaining positions in the square grid. In other words, with respect to the row and column directions, a line of two-pixel alternation (W pixel 4e and G pixel 4b) and a line of four pixel alternation (B pixel 4c, W pixel 4e, R pixel 4a and W pixel 4e) occur in turns. Note that although FIG. 2 only shows eight rows and eight columns, there are actually more rows and columns.

Referring back to FIG. 1, a separate vertical CCD 5 is provided along each column of the pixels. The vertical CCD 5 reads out the signal charge from the light receiving element of each pixels 4a-4c, and transfers the charge to the column direction (vertical transfer). Each vertical CCD 5 is commonly connected, at one end, to a horizontal CCD 6. The horizontal CCD 6 receives the signal charge, one row at a time, from each vertical CCD 5 and transfers the charge toward the row direction (horizontal transfer). A terminal end of the horizontal CCD 6 is connected to an output amplifier 7. The output amplifier 7 converts the signal charge from the horizontal CCD 6 into a voltage signal (pixel signal) proportional to the amount of charge, and outputs this voltage signal. The voltage signal is then transmitted to an image processor (not shown), which performs image processing for each color using the pixel signal from each color pixel (R pixel 4a, G pixel 4b and B pixel 4c) as a color signal and using the pixel signal from each W pixels 4e as a luminance signal.

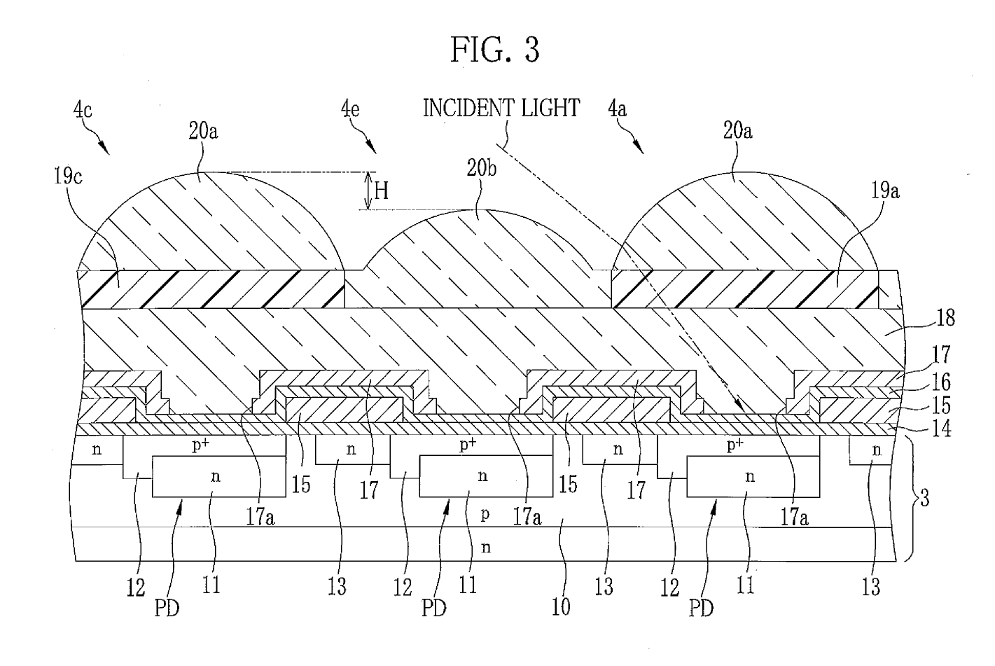

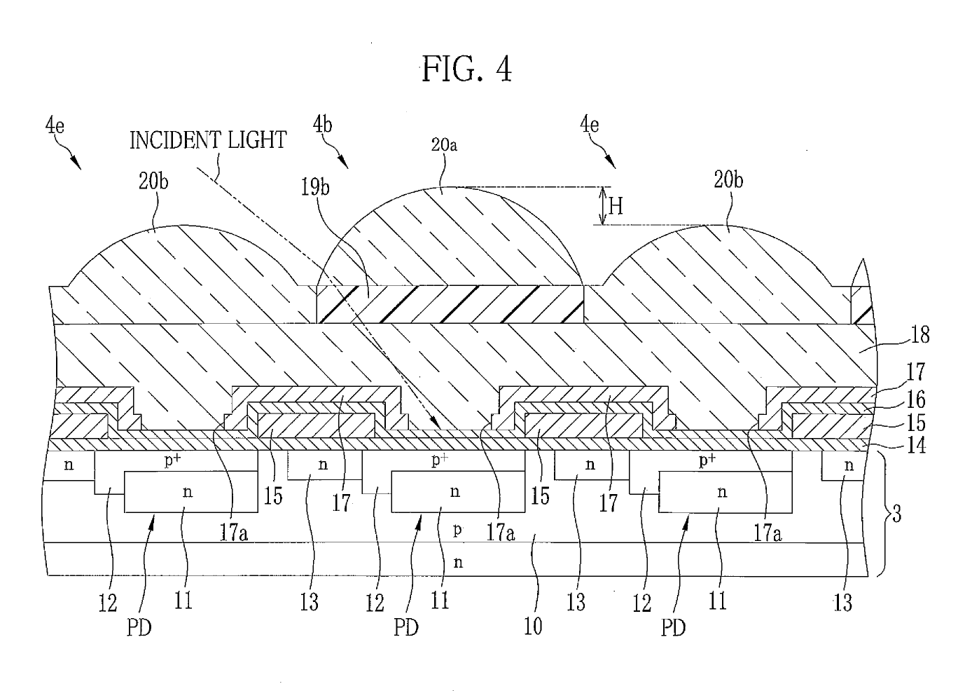

As shown in FIG. 3 and FIG. 4, the semiconductor substrate 3 is made of an n-type silicon substrate on which a p-type well layer 10 is formed. Inside the p-type well layer 10, there are n-type accumulation layers 11 to store the signal charge (electron) generated through photo-electric conversion. Formed on each accumulation layer 11 is a p⁺-type high concentration layer 12 to prevent dark current. A p-n junction between the p-type well layer 10 and the accumulation layer 11 makes up an embedded photodiode PD that works as the aforementioned light receiving element.

Up in the p-type well layer 10, n-type charge transfer channels 13 extend in the row direction (perpendicular to the sheet) to transfer the signal charges. Each charge transfer channel 13 is separated from accumulation layer 11 by the p-type well layer 10 and the high concentration layer 12. A transparent gate insulating film 14, made of silicon dioxide or the like, is formed over a top surface of the semiconductor substrate 3. Formed above the charge transfer channel 13, across the gate insulating film 14, are transfer electrodes 15. The transfer electrode 15 controls the readout of the signal charge from the accumulation layer 11, and controls the vertical transfer of the signal charge in the charge transfer channel 13. The transfer electrode 15 is made of polysilicon or such conductive silicon. The aforementioned vertical CCD 5 is made up of the charge transfer channel 13 and the transfer electrode 15.

The transfer electrodes 15 and the gate insulating film 14 are covered with a transparent interlayer insulating film 16 made of silicon dioxide or the like. On this interlayer insulating film 16 is formed a light shielding film 17, made of tungsten or the like, which covers the transfer electrodes 15 while providing an opening 17a above each photodiode PD. The incoming light enters the photodiode PD through this opening 17a. A transparent planarizing layer 18 lies over the openings 17a and the light shielding film 17. The planarizing layer 18 is made by firstly forming a BPSG (Boron Phosphorous Silicate Glass) layer through vapor deposition, and treating the layer with heat (reflow). Then, transparent resin material is applied and developed on this BPSG layer, and lastly the surface of the layer is flattened by CMP (Chemical Mechanical Polishing).

On the planarizing layer 18, R filters 19a to transmit red light, G filters 19b to transmit green light and B filters 19c to transmit blue light are provided at the positions to form the R, G, B pixels 4a, 4b and 4c. These color filters 19a-19c are made of resin material containing particular pigments, and have approximately the same thickness. At the positions to form the W pixels 4e, on the planarizing layer 18, the color filters are not provided.

A first micro-lens 20a is formed on each of the color filters 19a-19c. A second micro-lens 20b for each W pixel is formed directly on the planarizing layer 18. The second micro-lenses 20b are lower in height, by a height difference H, than the first micro-lenses 20a. The height difference H is approximately the same as the thickness of the color filters 19a-19c.

Since the second micro-lenses 20b of the W pixels 4e are lower than the first micro-lenses 20a of the adjoining color pixels (R, G, B pixels 4a, 4b, 4c), an incident angle range for incident light is large on the first micro-lenses 20a. Therefore, the first micro-lenses 20a achieve higher light-collection efficiency for oblique incident light than the second micro-lenses 20b. Even though the color pixels 4a-4c and the W pixels 4e have the same pixel size, the color signals from the color pixels 4a-4c become more intense than the luminance signals from the W pixels 4e. Therefore, the color signals and the luminance signals are well-balanced.

Additionally, since the color pixels 4a-4c and the W pixels 4e have the same pixel size in the solid state imaging device 2, there is no restriction on pixel arrangement to increase layout efficiency. Furthermore, since the W pixels 4e are arranged in a checkered pattern, the luminance resolution becomes equal in the row direction and the column direction. Therefore, with the solid state imaging device 2 of the present invention, the balance of the color signals and the luminance signals and the balance of the luminance resolution in the row direction and the column direction can be improved simultaneously, and color images can be produced with higher quality than before.

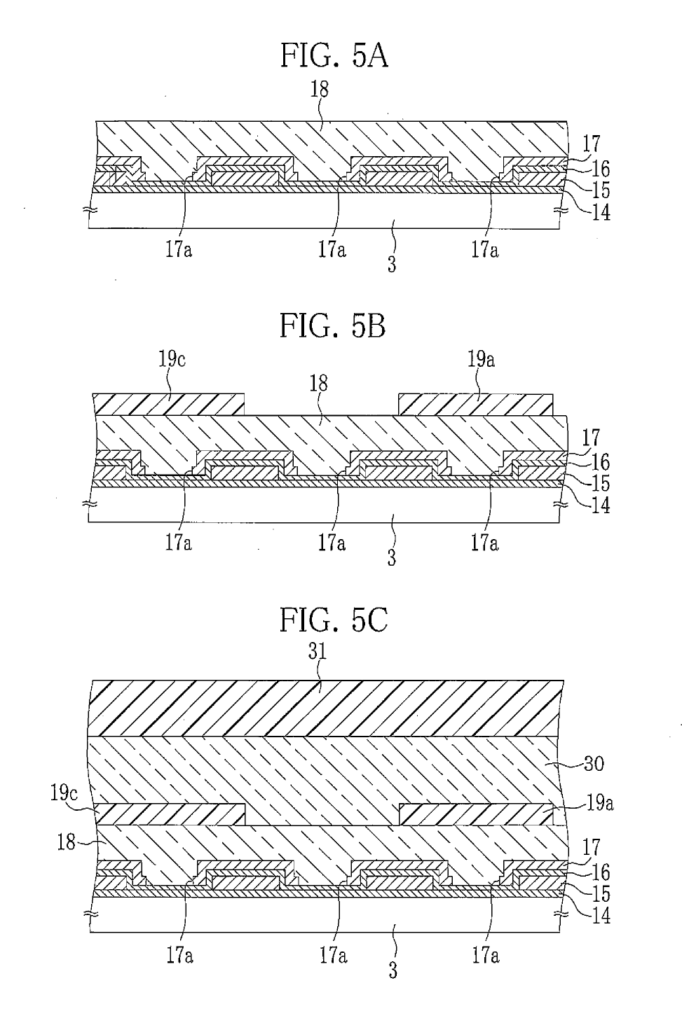

Next, the manufacturing process of the solid state imaging device 2 is explained with reference to FIG. 5 to FIG. 7, each of which is shown in cross-section along the III-III line in FIG. 1. Firstly, impurity ion is injected into the semiconductor substrate 3 so as to form the photodiodes PD and the charge transfer channels 13. Then, as shown in FIG. 5A, the transfer electrodes 15 and the light shielding film 17 are patterned on the semiconductor substrate 3, and a planarizing layer 18 is formed to cover the entire top surface.

Application of the photosensitive resin material containing particular pigments and the subsequent photolithography patterning process is repeated on the planarizing layer 18, and as shown in FIG. 5B, the color filters 19a-19c are formed at the positions of the color pixels. The residues of the photosensitive resin material for forming the color filters 19a-19c are then removed completely from the positions of the W pixels 4e.

Then, as shown in FIG. 5C, a transparent resin or other micro-lens material is deposited over the planarizing layer 18 and the color filters 19a-19c. This resin layer is flattened on the top surface, and turns into a lens layer 30. On this lens layer 30, a photosensitive resin material is applied to form a photosensitive resin layer 31. Note that the materials for the lens layer 30 and the photosensitive resin layer 31 are selected to show the same etching rate in the dry etching process.

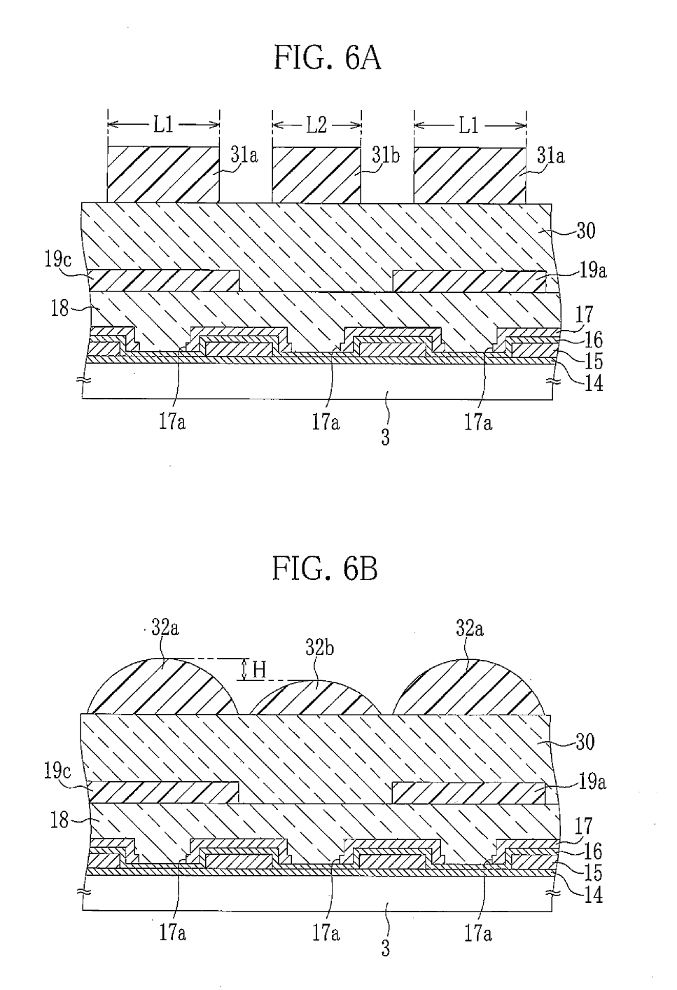

The photosensitive resin layer 31 is then patterned by the photolithography technique, which creates a first rectangular pattern 31a above each color pixel position and a second rectangular pattern 31b above each white pixel position, as shown in FIG. 6A. The second rectangular pattern 31b has a length L2 shorter than a length L1 of the first rectangular pattern 31a on each side.

The first and second rectangular patterns 31a, 31b are melted, by heat flow, into first and second lens matrixes 32a, 32b shown in FIG. 6B. Because of the difference of L1 and L2, the second lens matrix 32b is smaller than the first lens matrix 32a, and a height difference H in height occurs between the two.

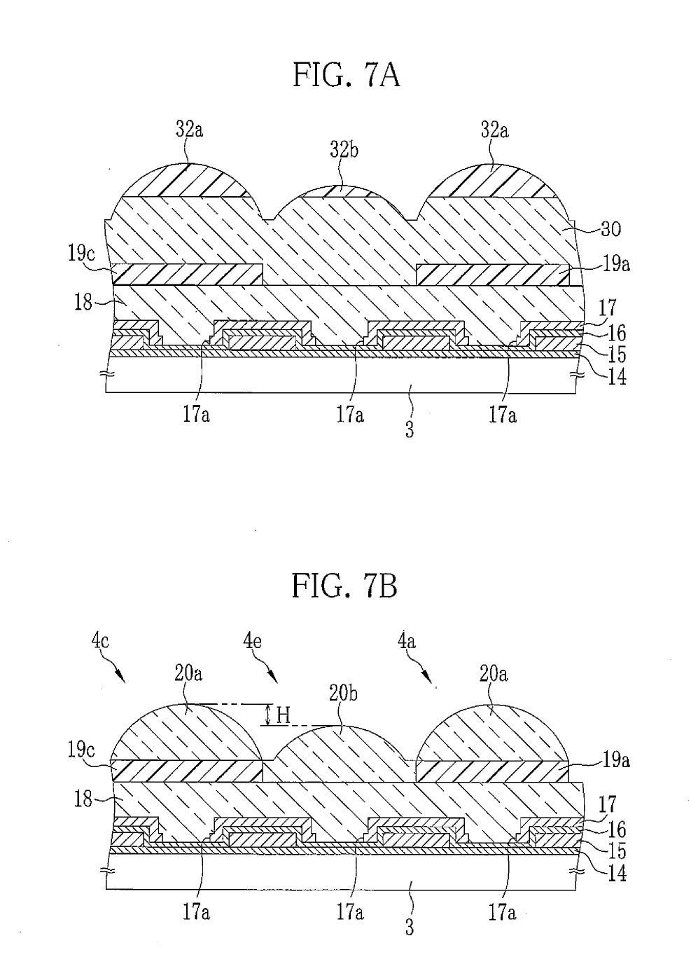

Using the first and second lens matrixes 32a, 32b as a mask, the lens layer 30 is etched (anisotropic dry etching) so as to transfer the shapes of the lens matrixes 32a, 32b and form the first and the second micro-lenses 20a, 20b. The product in the middle of the etching process is shown in FIG. 7A, where the lens matrixes 32a, 32b and the lens layer 30 are being etched at substantially the same etching rate. The product at the end of the etching process is shown in FIG. 7B, where the height difference H occurs between the first micro-lens 20a and the second micro-lens 20b. In this manner, the solid state imaging device 2 is manufactured.

Although the height difference H between the first and second micro-lenses is approximately the same as the thickness of the color filter in the above embodiment, the H can be set to an appropriate value as needed. In this case, the height difference H can be set by changing the ratio of the length L1 and L2, or by changing the heights of the rectangular patterns 31a, 31b.

In the above embodiment, the second micro-lenses are formed directly on the planaraizing layer. However, it is possible to provide, between the second micro-lenses and the planaraizing layer, a brightness filter, such as a clear or white filter, having a spectroscopic property correlative with brightness. In this case, the height difference H can be created by making the brightness filter thinner than the color filters, or by changing shape or curvature of the lens surface between the first micro-lenses and the second micro-lenses.

While the color pixels are red (R), green (G) and blue (B) in the above embodiment, the color pixels can be cyan (C), magenta (M) and yellow (Y).

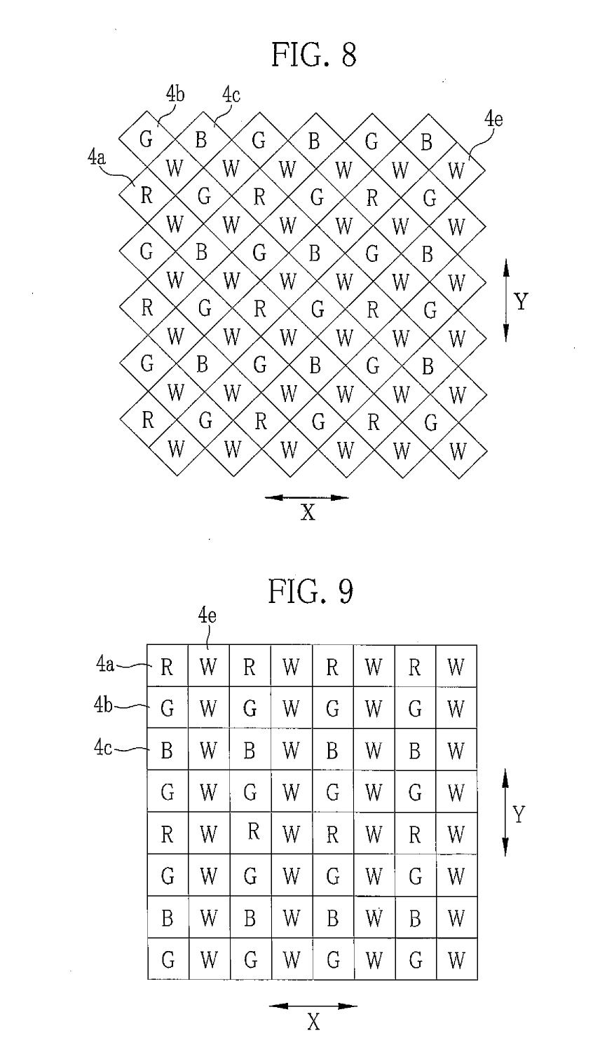

In the above embodiment, the pixels are arranged in the X-Y directions of a square grid. However, as shown in FIG. 8, the square grid can be rotated by 45 degrees with respect to the X-Y directions (the result is so-called a honeycomb arrangement).

Although the color pixels and the white pixels are arranged in a checkered pattern, so that each white pixel can adjoin four color pixels in the above embodiment, it is only necessary for each white pixel to adjoin at least one color pixel. In FIG. 9, a column of the color pixels and a column of the white pixels are arranged in stripes. In this arrangement, each white pixel adjoins two color pixels.

The present invention is not only applicable to the interline transfer imaging devices, but also to frame transfer imaging devices. Additionally, the present invention is applicable to the solid state imaging device of CMOS type. In the above embodiment, it is possible to provide an inner lens in the planarizing layer 18.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A solid state imaging device in which a plurality of light receiving elements that photo-electrically convert incident light into signal charge are arranged in a matrix in a semiconductor substrate, said solid state imaging device comprising:
regularly-arranged color pixels, each composed of a first light receiving element, among said plurality of light receiving elements, at a particular position in said matrix, a color filter disposed on a light incident side of said first light receiving element, and a first micro-lens disposed on a light incident side of said color filter; and
regularly-arranged white pixels, each composed of a second light receiving element, among said plurality of light receiving elements, adjoining at least one said first light receiving element, and a second micro-lens disposed on a light incident side of said second light receiving element and having a lower vertex than said first micro-lens.

2. The solid state imaging device of claim 1, wherein said color pixels are arranged in a checkered pattern, and said white pixels are arranged in a checkered pattern to be surrounded by said color pixels.

3. The solid state imaging device of claim 1 further comprising:
a planarizing layer formed on said semiconductor substrate, and having a flat top surface to support said color filters,
wherein said second micro-lenses are formed directly on said planarizing layer.

4. The solid state imaging device of claim 1, wherein said color pixels are red pixels having red filters to transmit red light, green pixels having green filters to transmit green light, and blue pixels having blue filters to transmit blue light.

5. The solid state imaging device of claim 1 further comprising:
a plurality of vertical CCDs extending along each column of said light receiving elements so as to receive said signal charge from each said light receiving element and transfer said signal charge to a vertical direction of said matrix;
a horizontal CCD for receiving and transferring said signal charge from each said vertical CCD to a horizontal direction of said matrix; and
an output amplifier for receiving said signal charge from said horizontal CCD and converting said signal charge into voltage signal and then outputting said voltage signal.
